(19) United States
(12) Patent Application Publication
(10) Pub. No.: US 2004/0004112 A1
(43) Pub. Date: Jan. 8, 2004

(54) Video game console and cashless method of use

(76) Inventor: Matthew Petruccelli, Hollywood, FL (US)

Correspondence Address: DAVID W. BARMAN, 1101 NE 176 TERRACE, NORTH MIAMI BEACH, FL, 33162, US

(21) Appl. No.: 10/191,250

(22) Filed: Jul. 8, 2002

(51) Int. Cl. G06F 17/00

(52) U.S. Cl. 235/375

(57) ABSTRACT

A novel video game console and method of use or disclosed and described

### SUMMARY OF THE INVENTION

The current invention relates to an improved video game console. More specifically, the current invention discloses and describes a video game console, which is designed to be quickly and easily reconfigured for changing games, and a cashless method for playing a game on said console.

### BACKGROUND OF THE INVENTION

In 1974 the world first witnessed the beginning of what was to be a new revolution in entertainment. It was in that year that “Pong” a video game depicting a ping-pong game was first introduced. Once the consumer public was overtaken, the industry has been on an odyssey to continually entertain and captivate their enthusiasts. As technology became more advanced, so did the games and the machines which play them. The machines have taken us from “Pong” through three-dimensional graphics and virtual reality. What has also continued to grow is the extraordinary revenue generated by the video game industry. Today, complex and sophisticated games are commonplace. Since the humble beginnings, video gaming has blossomed into a multi-billion dollar a year industry. Commercial video games, of the kind usually found in arcades and played on a pay-per-game basis, are still the backbone of the industry. These commercial machines are usually large, sturdy, and have the most sophisticated games. There is one major drawback. When a machine is assembled and configured, it is most often for one specific game. When that game no longer has the same popularity, the owner is forced to discard the entire unit. Attempts have been made, with varying degrees of success, to reconfigure older consoles to run newer games. Most of the time, the reconfigurations are logistically difficult to perform, and there are limitations as to the extent of reconfiguration possible. Also, reconfiguration of video game consoles can be costly. Oftentimes, it is easier and more cost effective to simply discard the unwanted console and purchase a new game. One such limitation is the user controls. They may or may not be compatible with multiple games. This can be illustrated using two very well known games from the past. The game Centipede is played with a track ball control, while the game Pac Man is played with a joystick. In order to change from one of these games to another, the control panel must be changed. Most video game consoles are not designed for the control panel to be changed. If there are opportunities to change, it is at a great expense of time and effort. The current invention is designed to overcome the difficulties of reconfiguration.

It is an object of the invention to provide a novel video game console that is easily reconfigured.

It is another object of the invention to provide a video game console in which the control panel is easily detachable.

It is another object of the invention to provide a video game console in which the control panel can be quickly and easily interchanged.

It is yet another object of the invention for the entire video game drawer to be easily disconnected and interchanged.

It is another object of the invention to provide a video game console in which the control panel can be interchanged to easily adapt to numerous games.

It is another object of the invention to provide a video game console in which the game played is quickly and easily changed.

It is another object of the invention to provide a video game console in which the game played is interfaced from a circuit board placed within the machine.

It is another object of the invention to provide a video game console in which the circuit board has quick connects and disconnects to both the control panel and display.

It is another object of the invention to provide a video game console which can be played with or without the use of currency.

It is another object of the invention to provide a video game console, which can be played without the use of currency or tokens. The user uses a computer read only chip to deduct money from a chip in which money was deposited and the value stored on the chip.

It is another embodiment of the invention for the cashless system to be used with a casino gambling machine, wherein debits are deducted from the stored cash value on a semiconductor chip, and winnings are credited to said chip.

### BRIEF DESCRIPTION OF THE DRAWINGS

FIG. 1 is the front view of the assembled console

FIG. 2 is a person sitting at the console.

FIG. 3 is the console showing removable computer motherboard

FIG. 4 is the console showing removable and interchangeable game controls

FIG. 5 shows removal of the monitor and game housing from the console stand

FIG. 6 is a schematic showing the integration of multiple game circuit boards within a single unit.

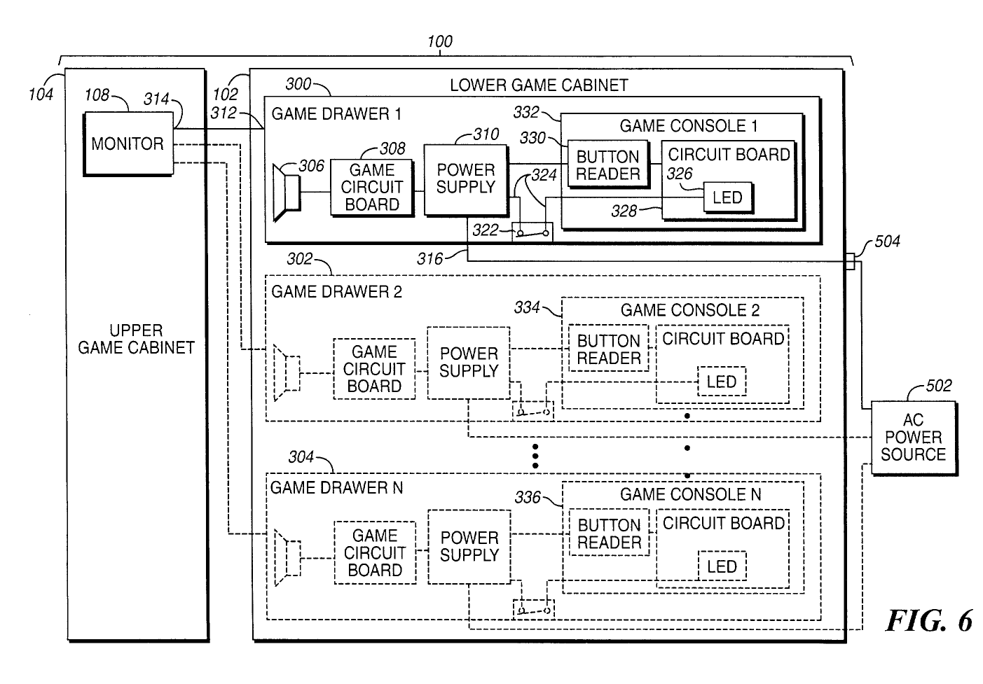

### DETAILED DESCRIPTION OF THE PREFERRED EMBODIMENT

The current invention allows for a user to access commercial pay-for-play video consoles, without the need for depositing currency or tokens. There is a commercially available product called the “I Chip” available from Dallas Semiconductor, Dallas, Tex. The chip is described in U.S. Pat No. 6,085,983, incorporated herein by reference. This patent describes a secure monetary system, by which monetary deposit information is stored on said chip. The current invention has produced novel software for performing the monetary transfer. A copy of one embodiment is submitted on CD-ROM and the contents are incorporated herein by reference. It is this novel software that provides a method for use of the established technology in a previously unexplored arena of commerce.

The commercial video arcade has been a major icon in our society for the previous 20+ years. Conventionally, patrons would use change machines to receive either quarters or tokens. Then, they would proceed from machine to machine with pockets filled with coins. The novel video game apparatus described herein would completely eliminate the need for any coins. Additionally, a method for transacting video gaming without the need for coins is sought as part of the invention. The method would be carried out as follows: A patron would enter an arcade or other appropriate area where commercial pay-for-play games are available. The patron would obtain a holder, which has a permanently mounted semiconductor chip. The patron would proceed to a terminal, which has mounted a standard dollar bill reader as is commonly known and used in commerce. The terminal would also have appropriately formed first and second conductive surfaces, which are combined to form a cavity appropriate for the insertion of the semiconductor chip. For the purposes of this invention, these combined conductive surfaces will be referred to as the chip receiver. The patron then inserts the semiconductor chip into a chip receiver. The chip receiver is interfaced, through said novel software, to provide a method transaction. The patron will deposit a desired amount of currency into the dollar bill reader, and the amount of deposit is subsequently stored on a chip. The patron will then remove the semiconductor chip and proceed to a gaming machine. The gaming machine can be any suitable electronic gaming device. Said gaming devices can include, but are not limited to: video arcade games, gaming machines, gambling machines, casino games, and video gambling games. The method is then directed to the removing a user initiated amount of currency and receiving credit on the desired video game. The desired game will also have a chip receiver and appropriate software for the transaction. Once the chip receiver transmits the presence of the chip, the software provides a method for the circuit board to read the stored information and ascertain if there is any monetary value on the chip. This is done using the aforementioned software. Each video game also has appropriate software to read the monetary information stored on the chip, and deducts appropriate amounts for games played. The user approaches a machine, inserts the semiconductor chip into the chip receiver, selects the amount of game credits desired, and starts playing.

Another novel feature of the current invention provides for the return of unused credits. An example is a patron that selects for two games to be played, and at the completion of the first game, desires to play a different game, or not play any more. The patron can have the game credits refunded and the monetary value restored to his semiconductor chip. Thus the current invention provides for a novel method for the commercial video patron to play multiple games, without the need for currency, coins or tokens.

In another embodiment, the software will place a series of award points onto the chip. In many arcades, tickets are awarded for attaining certain levels of scores on the games. These award tickets are then redeemed for prizes. This embodiment would eliminate the need for these award tickets. Alternatively, in a casino setting, the patron will have winnings deposited onto the chip. The patron will than redeem the total winnings at a cashier for cash or a cashiers check.

In another embodiment, the software may be used to track a patron's usage to determine the relative popularity of various games. The data relating to a patrons activity may include, but would not be limited to amount of time played, amount of money played, amount of winnings earned, or any combination thereof.

In another embodiment, casino or “gaming” games are equipped to receive payment from a user using the semi conductor chip. Additionally, in a casino atmosphere where allowable by law, the winnings of a patron may be credited onto the users chip. The user would cash in the winnings by going to a cashier and having the chip read for a current monetary value, and receiving compensation, in the form of a cash, check, or other appropriate payment for the value recorded on the chip.

The video console itself has been improved to provide several unique characteristics that are not found on commercially available machines. The control panels of commercially available video gaming equipment are not easily changed. If there were a machine capable of changing the game, it would be limited to interchange based on the control panel. It has been discovered that one is able to form the control panel onto a detachable door. Said detachable door is able to be unlocked and removed from the body of the console. The electronic and/or computer circuitry mounted to the board for both the controls and the semiconductor chip are designed so they may be disconnected from the video and electrical interfaces by means of a quick connect/disconnect mechanism. In forming the machine with the quick connect/disconnect, the entire drawer assembly may be removed and the commercial video game machine can be quickly and easily reconfigured to play another game. The electronic circuitry for individual games can be stored in the circuitry mounted to the board.

In another embodiment, the games are computer based and generated.

In another embodiment, the control panel also is removable and interchangeable by means of standard quick connect/disconnect. In this manner, if the game board already contains the appropriate programming for running multiple games, only the controls need be changed to accommodate the games' control requirements. The machine is readily changeable and reconfigurable to facilitate the change of games and controls.

Another feature of the console provides for the easy removal of the video monitor housing. Again, because the machine has electronic quick connect/disconnect, the monitor can be easily separated from its computer and electronic connections. The monitor is secured to the base with a plurality of mounting screws or other appropriate mounting means. The size, type, and number of mountings are easily ascertained and assigned by the machine designer and is determined by methods commonly known in the art.

Another embodiment provides for the mounting of more than one game circuit board within the video game assembly. The games may be interchanged externally, or internally by changing the connection using the quick connect/disconnect. The advantage of this embodiment is that it does not limit the owner of the console in the offering of games to the consumers.

In another embodiment the unit is portable and removable from the lower cabinet. In this embodiment, the machine can be placed on a tabletop, countertop or bar.

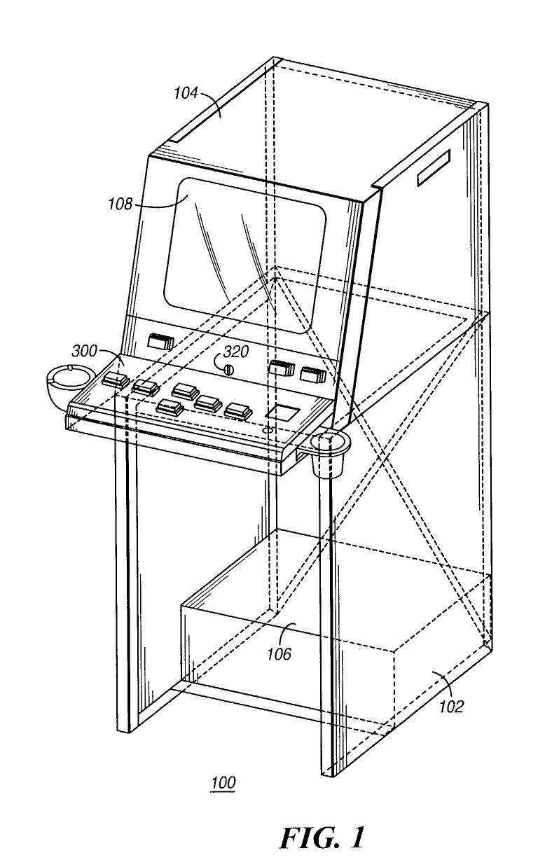

FIG. 1 shows the video console 100 with lower cabinet 102 that supports upper cabinet 104. Lower cabinet 102 may incorporate a footrest 106 for use when user is seated at the console. Incorporated into upper cabinet 104 is a video display 108 for viewing the game. Game drawer assembly 300 is mounted into upper cabinet 104 and locked and unlocked at 320 by any commonly used locking mechanism.

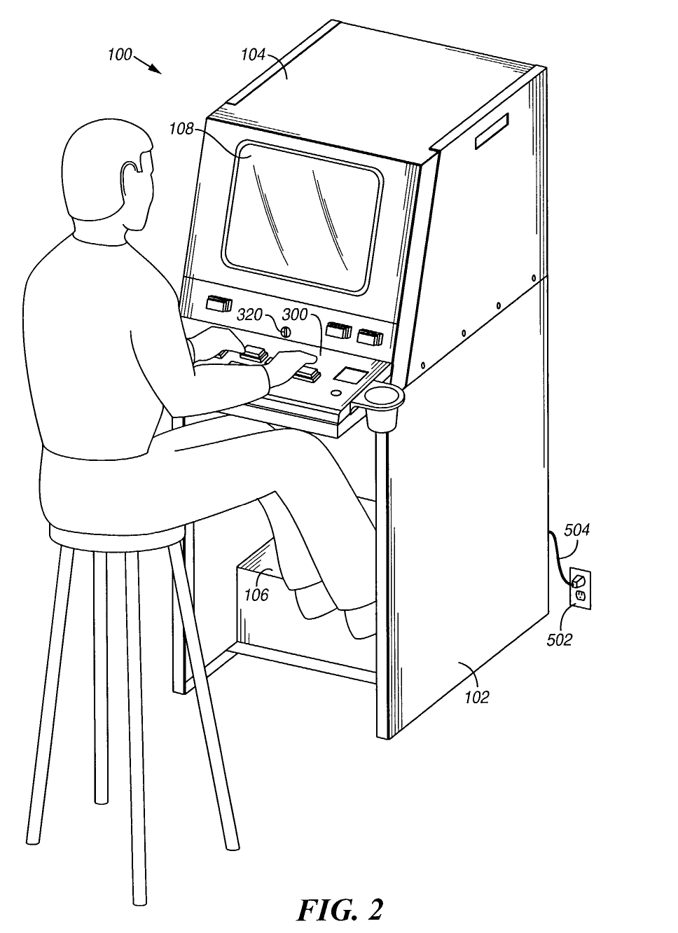

FIG. 2 shows a patron seated in front of the video console 100 with the aforementioned elements. Also shown in FIG. 2 is the electrical power cord 504, which connects to an appropriate source of electricity 502.

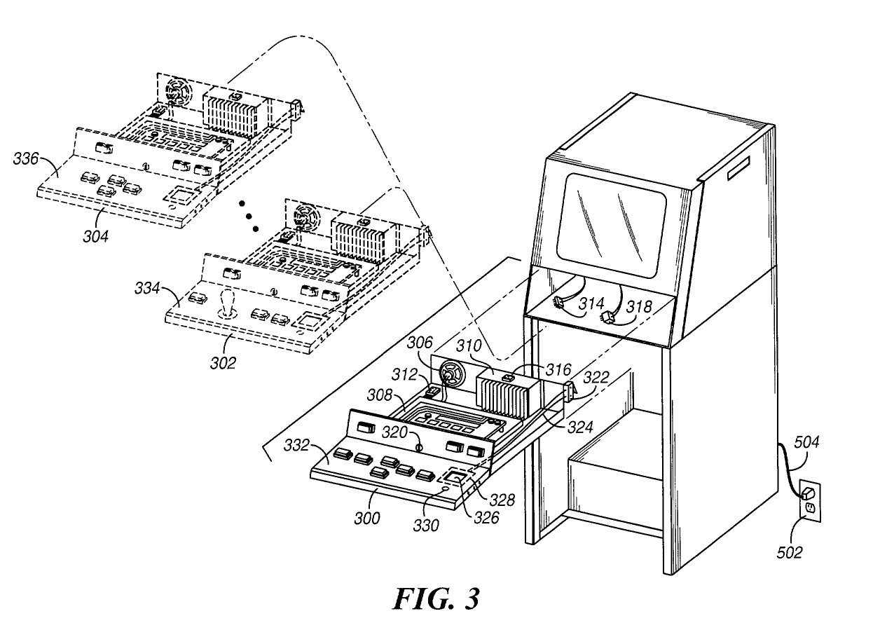

FIG. 3 shows the removal of the game drawer assembly 300. The drawer is disconnected from the video game console by removing both the electronic quick disconnect output 318, which supplies power to the power supply 316 which in turn delivers current to printed circuit board 308. Printed circuit board 308 is mounted onto drawer 300. Complete removal game drawer assembly 300 also requires removal of electronic quick disconnect input 314 from the electronic quick disconnect output 312 which supplies the signal to the video display. The game drawer assembly 300 also has mounted a speaker 306 suitable for providing appropriate audio for the game being played. The game drawer assembly 300 further contains a kill switch 322 and kill switch wires 324, which leads to the display 326. The kill switch provides a means of security by providing a mechanism by which the machine becomes disabled, either temporarily or permanently in order to prevent unauthorized access to any of the components housed within the console. The display can be a light emitting diode (LED), liquid crystal display (LCD) or any other suitable display. Mounted under display 326 is a circuit board 328, which provides the signal for the display 326. Mounted directly under display 326 is a chip receiver 330. The chip receiver is of appropriate size and shape to allow for the insertion of a mounted semiconductor chip. This allows for the patron to prepurchase a monetary value, which is stored on the chip. The video console has appropriate software, which allows for the circuitry to read the monetary value stored on the semiconductor chip, deduct an amount as determined by the user, and receive credit on the video game. FIG. 3 also shows varied embodiments of the game drawer. Game drawer 332 shows one possible configuration. Game drawer 334 shows an embodiment wherein the controls 302 have a joystick. Game drawer 336 shows even another embodiment showing the arrangement of the controls. These embodiments are given by way of example and are in no way intended to be limiting in their scope.

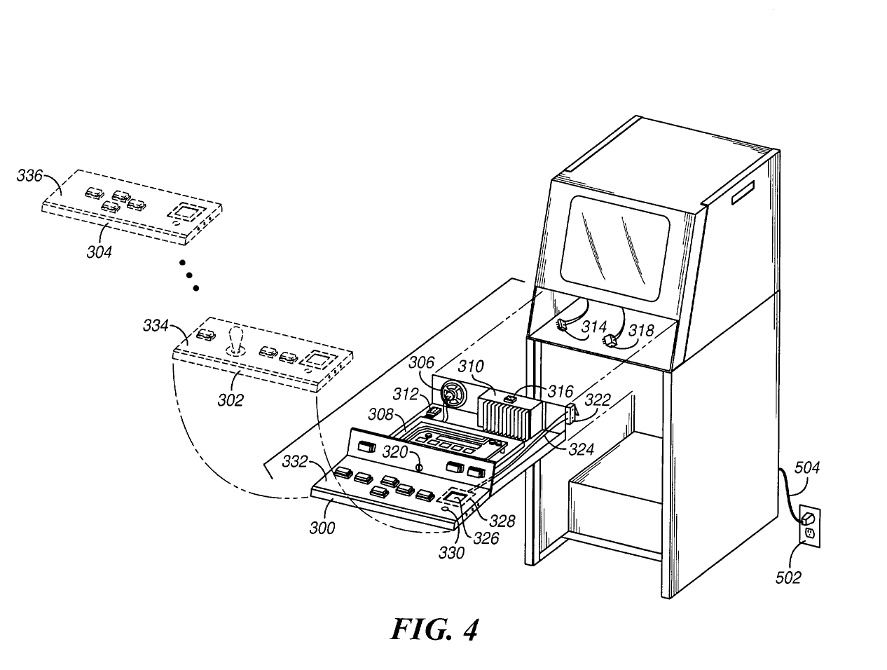

FIG. 4 shows another embodiment by which only the user controls dismount from the board and provide a means for reconfiguring the console. In this embodiment more than one circuit board is mounted within the console and the reconfiguring of the game is achieved by manually or electronically switching boards, and by changing the user controls, which are mounted to the drawer of the console.

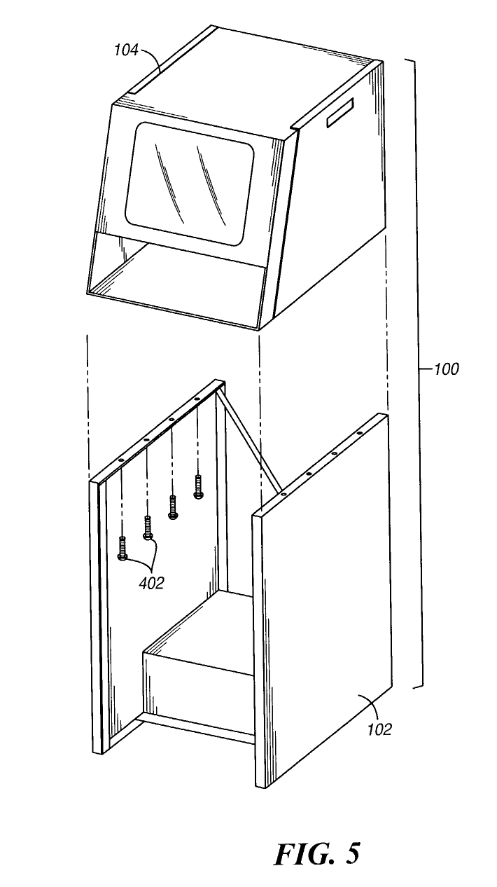

FIG. 5 shows the console 100 and depicts the mounting of upper cabinet 104 onto lower cabinet 102. The mounting in one embodiment can be conventional mounting screws 402. The mounting can be by any appropriate means.

These are provided by way of example and are in no means intended to limit the scope of the invention. While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. A video game console comprising:
(a) an upper cabinet, which contains a video display, power supply, audio components, computer circuitry, game drawer which further comprises user controls, mechanical and electronic security mechanisms, display for payment means, and a receiving means for semiconductor chip which provides for electronic payment without the use of currency or coins; and
(b) a lower cabinet which provides support for said upper cabinet.

2. The video game assembly of claim 1 wherein said video display is a cathode ray tube (CRT), liquid crystal display (LCD), or other suitable video display.

3. The video game assembly of claim 1 wherein said audio components comprise at least one output.

4. The video game assembly of claim 3 wherein said output is at least one standard audio speaker.

5. The video game assembly of claim 1 wherein said computer circuitry is mounted to said game drawer.

6. The video game assembly of claim 5 wherein said game drawer houses at least one circuit board.

7. The video game assembly of claim 6 wherein said game drawer houses a plurality of circuit boards.

8. The video game assembly of claim 7 wherein each of said plurality of circuit boards contains information for individual games.

9. The video game assembly of claim 1 wherein said game drawer is mechanically detachable from said upper assembly.

10. The video game assembly of claim 9 wherein said game drawer contains quick disconnects which disengages from all connectors contained within the upper cabinet for electrical and video components.

11. The video game assembly of claim 1 wherein said user controls are removable and interchangeable.

12. The video game assembly of claim 1 wherein said game drawer is removable and interchangeable.

13. The video game assembly of claim 1 wherein said security means temporarily disables all computer and electronic components.

14. The video game assembly of claim 1 wherein said security means permanently disables all computer and electronic components.

15. The video game assembly of claim 1 wherein said security means temporarily disables all components related to the electronic monetary exchange.

16. The video game assembly of claim 1 wherein said security means permanently disables all components related to the electronic monetary exchange.

17. The video game assembly of claim 1 wherein said display for payment is a light emitting diode (LED), liquid crystal display (LCD), or other suitable display means.

18. The video game assembly of claim 1 wherein said display for payment is controlled by a circuit board mounted underneath said display.

19. The video game assembly of claim 1 wherein said receiving means for semiconductor chip is a cavity formed of two conductive surfaces.

20. A method for storing and deducting monetary information on a semiconductor chip according to a novel program incorporated herein.

21. A method for providing for the monetary transaction, without the use of currency, coins or tokens, of using a video game using monetary information stored and deducted from a semiconductor chip according to the novel program incorporated herein.

22. A method for reconfiguring a video game console to play different games comprising the steps of:
(a) unlocking the game drawer,
(b) removing the game drawer,
(c) removing the quick disconnects which send at least video signals and electricity through standard wiring,
(d) replacing a different game drawer which contains a circuit board for a different game,
(e) connecting the video and electricity disconnects from the replaced drawer,
(f) locking the game drawer into the upper cabinet.

23. A method for reconfiguring a video game console to play different games comprising the steps of:
(a) unlocking the game drawer,
(b) selecting, either manually or electronically a different circuit board from a plurality of circuit boards mounted on game drawer or inside upper cabinet,
(c) removing and replacing user controls with interchangeable control panel,
(d) locking the game drawer into the upper cabinet.
